(19) United States
(12) Patent Application Publication
(10) Pub. No.: US 2017/0179779 A1
(43) Pub. Date: Jun. 22, 2017

(54) ROTOR LAMINATIONS HAVING REDUCED STRESS MAGNET STOP

(71) Applicant: GM GLOBAL TECHNOLOGY OPERATIONS LLC, Detroit, MI (US)

(72) Inventors: Edward L. Kaiser, Orion, MI (US); David A. Wyrembelski, Grand Blanc, MI (US)

(73) Assignee: GM GLOBAL TECHNOLOGY OPERATIONS LLC, Detroit, MI (US)

(21) Appl. No.: 14/974,730

(22) Filed: Dec. 18, 2015

(51) Int. Cl. H02K 1/27

(52) U.S. Cl. CPC H02K 1/274

(57) ABSTRACT

A rotor rotatable about an axis includes a plurality of magnets and a plurality of laminations stacked along the axis. The laminations have an outer surface distal from the axis and an inner surface proximal to the axis. A plurality of magnet slots are defined between the outer surface and the inner surface between an exterior barrier near the outer surface and an interior barrier near the inner surface. The magnets are disposed within the magnet slots between the exterior barrier and the interior barrier, such that a first end of the magnet is adjacent the exterior barrier and a second end of the magnet is adjacent the interior barrier. An inner retention stop extends into the magnet slots at the interior barrier, and is formed within the interior barrier nearer the outer surface.

### TECHNICAL FIELD

This disclosure generally relates to internal permanent magnet electric machines and, more particularly, to rotors for internal permanent magnet machines.

### BACKGROUND

An electric motor uses electric potential energy to produce mechanical energy through the interaction of magnetic fields and current-carrying conductors. The reverse process, using mechanical energy to produce electrical energy, is accomplished by a generator or dynamo. Other electric machines, such as motor/generators, combine various features of both motors and generators.

Electric machines may include an element rotatable about a central axis. The rotatable element, which may be referred to as a rotor, may be coaxial with a static element, which may be referred to as a stator. The electric machine uses relative rotation between the rotor and stator to produce mechanical energy, electrical energy, or combinations thereof.

### SUMMARY

A rotor rotatable about an axis, and usable within an electric machine, is provided. The rotor includes a plurality of magnets and a plurality of laminations that are stacked along the axis.

The laminations have a body with an outer surface distal from the axis and an inner surface proximal to the axis. A plurality of magnet slots are defined between the outer surface and the inner surface and may be angling between an exterior barrier near the outer surface and an interior barrier near the inner surface. The magnets are disposed within the magnet slots between the exterior barrier and the interior barrier, such that a first end of the magnet is adjacent the exterior barrier and a second end of the magnet is adjacent the interior barrier.

An inner retention stop extends into the magnet slots at the interior barrier and abuts the second end of the magnet. The inner retention stop is formed on the side of the magnet slot nearer the outer surface of the interior barrier.

The above features and advantages, and other features and advantages, of the present subject matter are readily apparent from the following detailed description of some of the best modes and other embodiments for carrying out the disclosed structures, methods, or both.

### BRIEF DESCRIPTION OF THE DRAWINGS

FIG. 1 is a schematic diagram of an electric machine having a rotor formed from multiple laminations.

FIG. 2 is a schematic end view of one of the laminations of the rotor, such as that shown and described in FIG. 1.

FIG. 3 is a schematic detail view of a portion of the rotor lamination of FIG. 1, showing an inner magnet stop.

FIG. 4 is a schematic detail view of a portion of another rotor lamination, similar to that shown in FIG. 1, having an inner magnet stop with modified geometry.

### DETAILED DESCRIPTION

Referring to the drawings, wherein like reference numbers correspond to like or similar components whenever possible throughout the several figures, there is shown in FIG. 1 a schematic diagram of an electric machine 10. FIG. 1 illustrates the general components and orientation of the electric machine 10, including a stator 12, which is a fixed component, and a rotor 14, which is rotatable about an axis 16.

As diagramed in FIG. 1, the rotor 14 includes a plurality of lamination sheets or laminations 20. Each of the laminations 20 is preferably manufactured from steel, such as but not limited to non-orientated electrical steel. The laminations 20 are stacked or disposed adjacent each other along the axis 16 to define a core of the rotor 14. In many configurations, the laminations 20 will be affixed to each other—via adhesives, welding, fasteners, mechanical staking (interlocking), or the like—to form the core.

A plurality of magnets 22 are located within the rotor 14. The magnets 22 are permanent magnets, such that the electric machine 10 may be referred to as an interior permanent magnet electric machine 10.

While the present invention may be described with respect to specific applications or industries, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

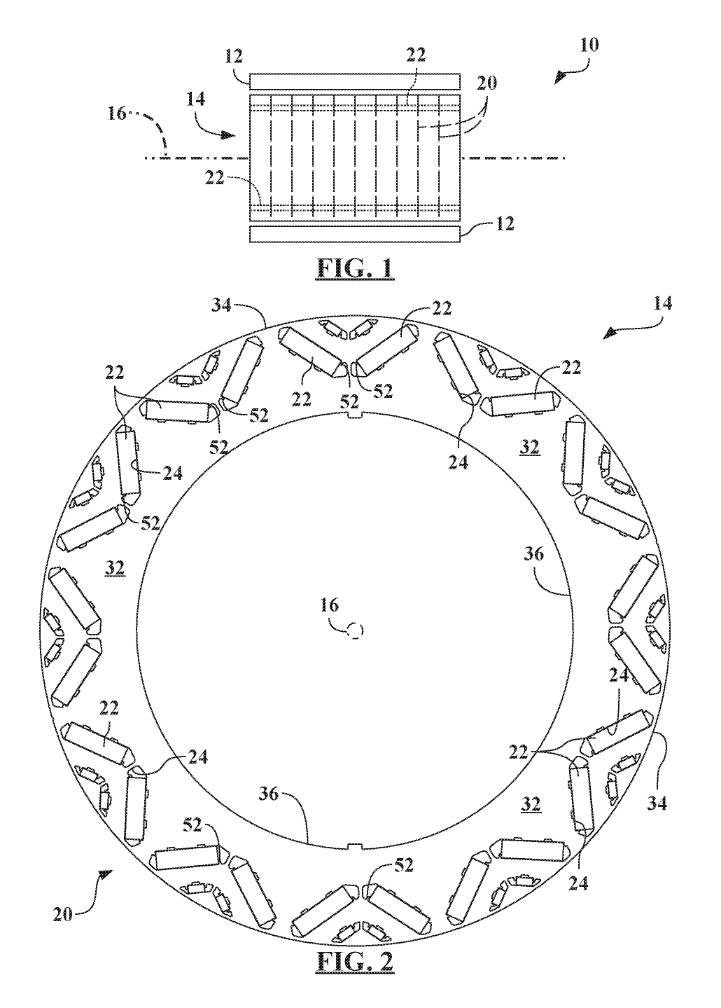

Referring also to FIG. 2, there is shown an end view of the rotor 14, illustrating one of the laminations 20 and the magnets 22. As shown in FIG. 2, each of the laminations 20 defines at least one, and preferably a plurality, of apertures or magnet slots 24.

An aperture punch may be used to form the magnet slots 24 within each of the laminations 20, such that a single or progressive die manufacturing process may form the laminations 20. When the laminations 20 are aligned along the axis 16 and relative to each other, the plurality of magnet slots 24 in the laminations 20 are aligned with each other to define axial slots, within which the magnets 22 are disposed. The magnet slots 24 in the illustrative rotor 14 are substantially parallel with the axis 16.

The laminations 20 shown are formed from a one-piece body 32. However, other laminations 20 may be formed from segments that are assembled or pieced together. The body 32 has an outer diameter or outer surface 34 distal from the axis 16 and an inner surface 36 proximal to the axis 16. The outer surface 34 and the inner surface 36 are surfaces or edges defined at generally equal distances from the axis 16. The outer surface 34 may also be referred to as an outer edge, outer diameter, or O.D., and the inner surface 36 may also be referred to as an inner edge, inner diameter, or I.D.

The magnet slots 24 are defined between the outer surface 34 and the inner surface 36 of the laminations 20. The description herein is concerned largely with the larger pairs of magnets 22 of the rotor 14. However, similar principles may apply to the smaller magnet pairs located nearer the outer surface 34.

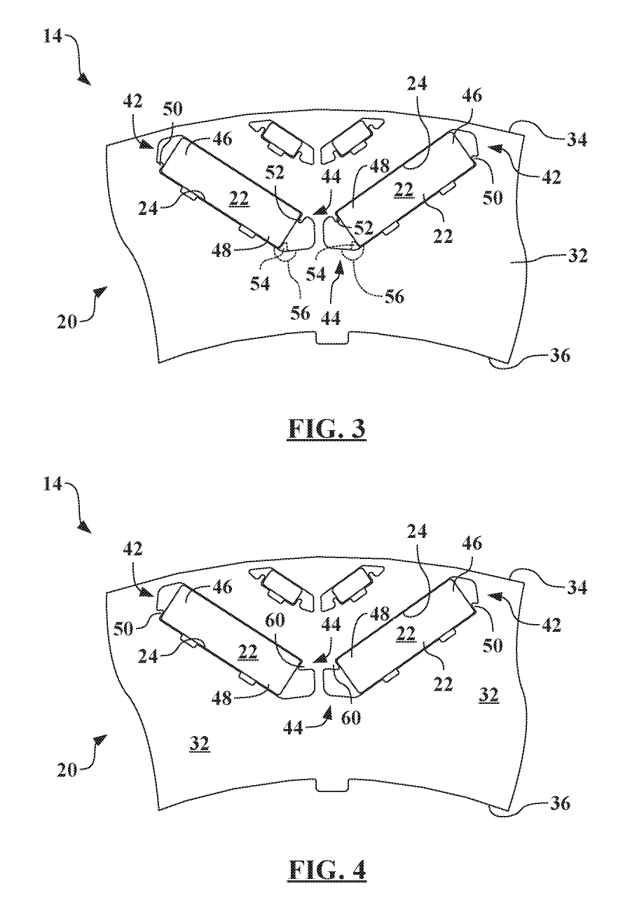

Referring also to FIG. 3, there is shown a detail view of a portion of the rotor 14. In the configuration shown in FIGS. 2 and 3, the magnet slots 24 angle between an exterior barrier 42 at the end of the magnet slots 24 closer to the outer surface 34 and an interior barrier 44 at the end of the magnet slots 24 closer to the inner surface 36. Either of the exterior barrier 42 and the interior barrier 44 may alternatively be referred to as first and second barriers.

The magnets 22 are disposed within the magnet slots 24 between the exterior barrier 42 and the interior barrier 44. A first end 46 of the magnets 22 is adjacent the exterior barrier 42 and a second end 48 of the magnets 22 is adjacent the interior barrier 44. Note the designation of the ends of the magnets 22 as first or second is interchangeable. In other embodiments, the magnet slots 24 may be substantially parallel, such that the first end 46 and the second 48 of the magnets 22, and the barriers of the magnet slots 24, are substantially equidistant from the axis 16.

The magnets 22 are held or located within the magnet slots 24 by one or more retention features. Therefore, as the rotor 14 spins, and as the magnets 22 are subjected to electromagnetic forces, the magnets 22 do not move within the magnet slots 24.

An outer retention stop 50 is formed on the body 32 and extends into the magnet slots 24 at the exterior barrier 42. The outer retention stop 50 abuts the first end 46 of the magnet 22. An inner retention stop 52 is formed on the body 32 and extends into the magnet slots 24 at the interior barrier 44. The inner retention stop 52 abuts the second end 48 of the magnet 22. Either of the outer retention stop 50 and the inner retention stop 52 may alternatively be referred to as a first or second retention stop.

In the configuration shown, each of the magnets 22 is abutted by the outer retention stop 50 and the inner retention stop 52. However, other configurations may alternate the type and locations of retention features or stops.

In the configuration shown in FIGS. 2 and 3, the outer retention stop 50 is formed on the side of the exterior barrier 42 that is closer to the inner surface 36. Contrarily, the inner retention stop 52 is formed on the side of the interior barrier 44 that is nearer to the outer surface 34 than to the inner surface 36.

An alternative inner stop 54 is also illustrated in FIG. 3 in dashed lines. The alternative inner stop 54 is located nearer the inner surface 36 within the interior barrier 44 and is illustrated to contrast the location of the inner retention stop 52 and to illustrate differences therebetween.

During operation of the electric machine 10, the rotor 14 spins at high speeds and the magnets 22 are subjected to electromagnetic forces. FIG. 3 illustrates a stress region 56 resulting from operation of the electric machine 10.

Comparing laminations 20, testing and analysis shows that the stress region 56 sees a reduction of between 20-25 percent in the max stress at a relatively high operating speed with the inner retention stop 52 as opposed to the alternative inner stop 54. Therefore, moving the stop feature from the location of the alternative inner stop 54 to the inner retention stop 52 may reduce the stress experienced in, at least, the interior barrier 44 of the laminations 20.

Additionally, reducing the stress levels of the laminations 20, by using the inner retention stop 52 instead of the alternative inner stop 54, the maximum allowable operating speed of the rotor 14, and therefore the electric machine 10, has been shown to increase by 10-15 percent. Testing and analysis have also shown that additional benefits of locating the stop feature at the inner retention stop 52, as opposed to the alternative inner stop 54, include reduction in torque ripple of between 20-25 percent.

The figures show the core of the rotor 14 assembled from stacked laminations 20. However, similar design principles apply to solid, as opposed to laminated, rotor cores, such as those machined from billet or formed as castings. Therefore, the magnet slots 24 of a solid core may also benefit from inclusion of the inner retention stop 52 instead of the alternative inner stop 54.

Referring also to FIG. 4, there is shown another detail view of a portion of the rotor 14 having alternative geometry. A smoothed inner stop 60, having slightly different geometry from the inner retention stop 52 shown in FIGS. 2 and 3, is illustrated in FIG. 4. The smoothed inner stop 60 further reduces stress concentrations by reducing sharp angles, as compared with the inner retention stop 52 of FIGS. 2 and 3.

The detailed description and the drawings or figures are supportive and descriptive of the subject matter discussed herein. While some of the best modes and other embodiments for have been described in detail, various alternative designs, configurations, and embodiments exist.

1. A rotor rotatable about an axis, comprising:
a plurality of magnets; and
a plurality of laminations stacked along the axis, including:
an outer surface distal from the axis;
an inner surface proximal to the axis;
a plurality of magnet slots defined between the outer surface and the inner surface and angling between an exterior barrier near the outer surface and an interior barrier near the inner surface, wherein the magnets are disposed within the magnet slots between the exterior barrier and the interior barrier, such that a first end of each magnet is adjacent the exterior barrier and a second end of each magnet is adjacent the interior barrier;
an inner retention stop extending into each magnet slot at the interior barrier and abutting the second end of each magnet, wherein the inner retention stop is nearer the outer surface of the interior barrier.

2. The rotor of claim 1, wherein the laminations further include:
an outer retention stop extending into each magnet slot at the exterior barrier and abutting the first end of each magnet.

3. A rotor rotatable about an axis, comprising:
one or more magnets; and
one or more laminations stacked along the axis, including:
a body having an outer surface distal from the axis and an inner surface proximal to the axis;
one or more magnet slots defined between the outer surface and the inner surface, wherein the magnets are disposed within the magnet slots; and
a first retention stop extending into the magnet slots and abutting a first end of the magnet, wherein the first retention stop extends from a side of the magnet slots that is nearer to the outer surface.

4. The rotor of claim 3, wherein the laminations further include:
a second retention stop extending into the magnet slots and abutting a second end of the magnet, wherein the second retention stop extends from a side of the magnet slots that is nearer to the inner surface.

5. A lamination for a rotor configured to rotate about an axis, comprising:
a body having an outer surface distal from the axis and an inner surface proximal to the axis;
a plurality of magnet slots defined between the outer surface and the inner surface and angling between an exterior barrier near the outer surface and an interior barrier near the inner surface, wherein the magnets are disposed within the magnet slots between the exterior barrier and the interior barrier, such that a first end of each magnet is adjacent the exterior barrier and a second end of each magnet is adjacent the interior barrier;
an inner retention stop extending into each magnet slot at the interior barrier and abutting the second end of each magnet, wherein the inner retention stop is nearer the outer surface within each interior barrier.

6. The lamination of claim 5, further comprising:
an outer retention stop extending into each magnet slot at the exterior barrier and abutting the first end of each magnet, wherein the outer retention stop is nearer the inner surface within each exterior barrier.
